(19) United States
(12) Patent Application Publication
(10) Pub. No.: US 2009/0110369 A1
(43) Pub. Date: Apr. 30, 2009

(54) MOVING IMAGE AND AUDIO REPRODUCTION DEVICE

(75) Inventors: Hideaki Takahashi, Fussa-shi (JP); Koji Maruyama, Akishima-shi (JP); Ryo Watanabe, Musashino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSJIBA, Tokyo (JP)

(21) Appl. No.: 12/248,535

(22) Filed: Oct. 9, 2008

(30) Foreign Application Priority Data
Oct. 31, 2007 (JP) 2007-284098

(51) Int. Cl. H04N 5/91

(52) U.S. Cl. 386/96

(57) ABSTRACT

According to one embodiment, a moving image and audio reproduction device includes an extraction block which extracts a composition of an Elementary Stream in an Audio Stream included in content and a setting shown in the Elementary Stream, and a signal processing part which reproduces the Audio Stream in accordance with the composition of the Elementary Stream in the Audio Stream and the setting shown in the Elementary Stream, extracted by the extraction block.

### CROSS-REFERENCE TO RELATED APPLICATIONS

This application is based upon and claims the benefit of priority from Japanese Patent Application No. 2007-284098, filed Oct. 31, 2007, the entire contents of which are incorporated herein by reference.

### BACKGROUND

1. Field

One embodiment of the invention relates to a moving image and audio reproduction device, which, in the reproduction of an arbitrary stream compressed by a plurality of CODECs (compression method), can output the best composition and setting of the CODEC to a connected receiving device, and a method for audio reproduction.

2. Description of the Related Art

In many cases, moving image (video) information and sound (music/audio) information held (recorded) in a recording medium are compressed by various methods (CODEC) for the purpose of reducing the recording capacity and expanded (decoded) when being reproduced.

The content accommodated on an optical disc as a recording medium is formed of a plurality of streams and may be compressed by a different CODEC in each stream.

As an optical disc widely used as a recording medium, there are widespread use of an optical disc with a CD format, which is used mainly for recording music data, and an optical disc with a DVD format which has a recoding capacity exceeding 6 times that of the optical disc with a CD format and is used mainly for recording video (moving image) and sound (audio).

Incidentally, an optical disc with a High-Definition (HD) DVD format which is provided by developing the DVD format and has a recording capacity of about 5 times that of the optical disc with a DVD format has already been put to practical use.

Meanwhile, as a reproduction device for reproducing information recorded on an optical disc, that is, as a player device, there has been practically applied a reproduction device which includes a bidirectional communication interface typified by, for example, a High-Definition Multimedia Interface (HDMI) and, when reproducing video (moving image) information and sound (audio) information from content (including programs and playlist) accommodated on an optical disc, can detect the presence or absence of connection of a receiving device connected to the player device, such as an AV controller (and a speaker connected to the AV controller) and a television receiver (monitor device), and the reproduction performance of the connected receiving device.

For example, Japanese Patent Application Publication (KOKAI) No. 2007-180612 discloses a moving image reproduction device which extracts the composition of a plurality of audio CODECs applied to a plurality of audio streams included in content and the setting of each audio CODEC and video-outputs a display signal used for displaying a list of the extracted compositions of the audio CODECs for the audio streams and the extracted setting of each audio CODEC.

However, the moving image reproduction device disclosed in the Publication only displays a list of the result of the extraction of the composition of audio CODECs to be applied to the audio streams included in the content and the setting of each audio CODEC, that is, displays a list of the extracted compositions of the audio CODECs and the extracted setting of each audio CODEC. Therefore, it is required that, after confirming the reproduction performance of a receiving device connected to the reproduction device, that is, an AV controller and a television receiver, the audio CODEC is set in accordance with the reproduction performance displayed as a list.

Accordingly, depending on the CODEC being set, there are the following problems that:
a) intended audio cannot be reproduced (by CODEC);
b) even though a further higher CODEC can be selected, audio is reproduced with remaining performance (the audio can be reproduced with sound quality of a little higher bit rate); and
c) it is necessary to grasp the reproduction performance of a receiving device and change the setting of a player device (moving image and audio reproduction device).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a video and audio reproduction device (player device) to which an example of an embodiment of the invention can be applied, according to an embodiment of the invention;

FIG. 2 is an exemplary diagram showing an example of a bitstream output (HBR audio [recommended by Dolby]) and a display (list) accommodated in a disc in the player device shown in FIG. 1, according to an embodiment of the invention;

FIG. 3 is an exemplary diagram showing an example of a bitstream output (HBR audio [recommended by DTS]) and a display (list) accommodated in a disc in the player device shown in FIG. 1, according to an embodiment of the invention;

FIG. 4 is an exemplary diagram showing an example of a method for detecting an Elementary Stream in an Audio Stream in the player device shown in FIG. 1 according to an embodiment of the invention;

FIGS. 5A and 5B are exemplary diagrams each showing an example of bsi data of audio content (which can be read (reproduced) by the player device shown in FIG. 1) shown (described) in the Elementary Stream, according to an embodiment of the invention;

FIG. 6 is a flowchart showing an example of a method for detecting audio format of HBR audio from header information in data of an Audio Stream in the player device shown in FIG. 1, according to an embodiment of the invention;

FIG. 7 is an exemplary diagram showing an example of the audio format (which can be read (reproduced) by the player device shown in FIG. 1) described in header information in data of an Audio Stream, according to an embodiment of the invention;

FIG. 8 is an exemplary diagram showing an example of a method for setting the audio format of a selected Audio Stream, which will be output to a receiving device, when an HD DVD disc actually set in a video and audio reproduction device is reproduced, according to an embodiment of the invention;

FIG. 9 is an exemplary diagram showing an example of a method for setting the audio format of a selected Audio Stream, which will be output to a receiving device, when an HD DVD disc actually set in a video and audio reproduction device is reproduced, according to an embodiment of the invention;

FIG. 10 is an exemplary diagram showing an example of a description in a Video Title Set Information Management Table (VTSI_MAT), according to an embodiment of the invention;

FIG. 11 is an exemplary diagram showing an example of a description of an Audio Stream attribute table (audio stream attribute table of VTS) in VTSI_MAT, according to an embodiment of the invention;

FIG. 12 is an exemplary diagram showing an example of a description of an audio coding sub-mode (Audio Coding Mode) in an Audio Stream Attribute, according to an embodiment of the invention;

FIG. 13 is an exemplary diagram showing an example of a description of an audio coding sub-mode (Audio Coding Mode) in an Audio Stream Attribute (compatible with DTC), according to an embodiment of the invention;

FIG. 14 is an exemplary diagram showing an example of a description of an audio coding sub-mode (Audio Coding Mode) in an Audio Stream Attribute, according to an embodiment of the invention; and

FIG. 15 is an exemplary diagram showing an example of an alignment of an audio data region in a plurality of audio packs (A_PCK) respectively provided in EVOBS, EVO, and EVOBU in a data region including an audio coding sub-mode, according to an embodiment of the invention.

### DETAILED DESCRIPTION

Various embodiments according to the invention will be described hereinafter with reference to the accompanying drawings. In general, according to one embodiment of the invention, a video and audio reproduction device comprising: extraction means for extracting a composition of an Elementary Stream in an Audio Stream included in content and a setting of the Elementary Stream; and reproduction means for reproducing the Audio Stream in accordance with the composition of the Elementary Stream in the Audio Stream and the setting of the Elementary Stream, extracted by the extraction means.

Embodiments of this invention will be described in detail with reference to the drawings.

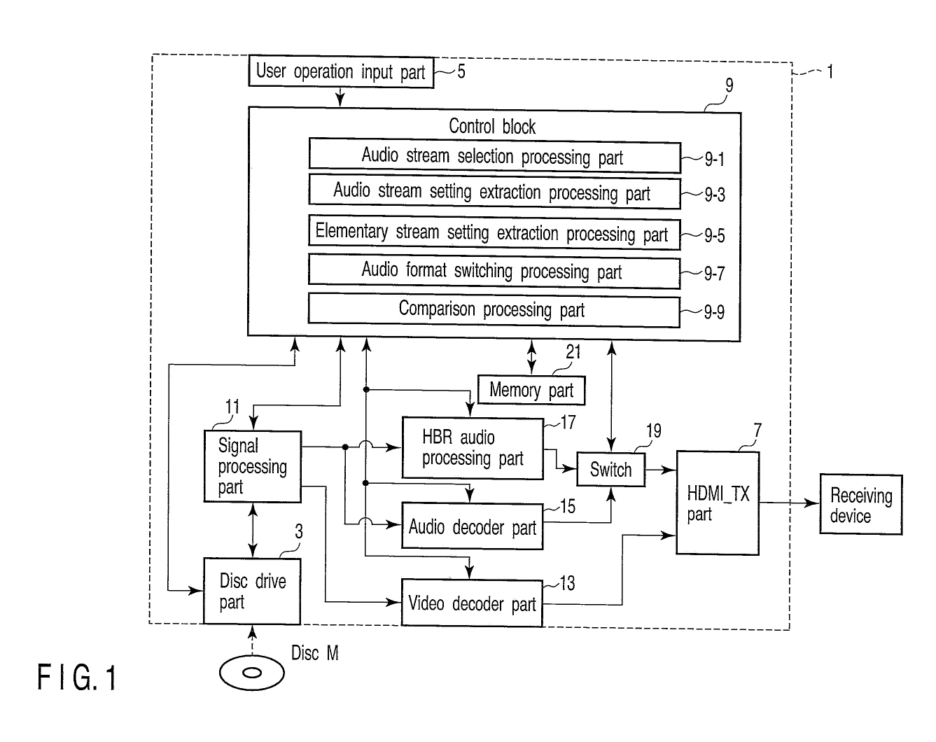

FIG. 1 shows an example of a moving image and audio reproduction device (player device) to which the embodiment of the invention can be applied. The moving image and audio reproduction device according to the invention is not limited to a player device, but includes a recorder device, a video camera, and the like which can record video and audio. Needles to say, the moving image and audio reproduction device may be a personal computer (PC), a disc drive device capable of being connected to PC, or a navigation device mounted in a vehicle or the like. The moving image and audio reproduction device may be simply called a transmitting device (or transmitting and receiving device) and this is because the moving image and audio reproduction device provides a function as a signal transmitting device (transmitting device) with respect to a TV (television) receiver connected to the moving image and audio reproduction device, a monitor device which can display a television broadcasting program and the like, or an audio-video (AV) amplifier (controller).

A video and audio reproduction device (moving image and audio reproduction device) 1 shown in FIG. 1 includes a disc drive unit 3, a user operation input part 5, a High-Definition Multimedia Interface (HDMI) part (HDMI Tx) 7, and a control block 9. A recording medium, such as an optical disc of DVD format and an optical disc M, which has HD DVD format as an expanded DVD format and can record and reproduce information using laser beam with a wavelength of 405 nm, is set in the video and audio reproduction device 1, whereby the disc drive unit 3 can reproduce the information accommodated in the optical disc M. The user operation input part 5 receives an operation signal representing the instruction from a user through, for example, a wireless remote terminal or an infrared remote terminal (not shown). The HDMI Tx 7 allows a bidirectional communication (transmission/reception of a signal) with a receiving device connected to the video and audio reproduction device 1. The control block 9 controls the operation of at least one of the disc drive unit 3, the user operation input part 5, and the HDMI Tx 7 and the transmission/reception of a signal among them.

It goes without saying that the disc drive unit 3 can reproduce not only information (content) recorded on a disc of HD DVD format but also information (content) recorded on an optical disc of DVD format and an optical disc of CD format, which are widely used at present. In addition, it goes without saying that the disc drive unit 3 may be a recording and reproducing type disc drive unit which can record information (content) on an optical disc of an arbitrary format.

The disc drive unit 3 is connected to the control block 9 through a digital signal processing part (DSP) 11, which detects the data (a prepit [emboss pit] or a recording mark string) recorded in an optical disc as the difference in the brightness and darkness of a light or the reflectance to encode (binarize) the data, and to reproduce the data as the content recorded on the optical disc. If the disc drive unit 3 is a recording and reproducing type disc drive unit which can write data in an optical disc set therein, a write signal binarized based on the data to be recorded is supplied to the disc drive unit 3, whereby the disc drive unit 3 can record (write) information on the optical disc.

The signal processing part (DSP) 11 is connected to the HDMI Tx 7 through a video decoder part 13, an audio decoder part 15, and an HBR audio processing part 17 complying with, for example, HDMI 1.3 and IEC 61937. A selector (switch) 19 is provided between the audio decoder part 15 and the HDMI Tx 7, in other words, between the HBR audio processing part 17 and the HDMI Tx 7. At least one of the audio decoder part 15 and the HBR audio processing part 17 is connected to the HDMI Tx 7 by the switching performed by the switch 19 (two audio decoder parts are not simultaneously connected to the HDMI Tx 7). In FIG. 1, although the switch 19 is illustrated as a block like hardware for illustrative purposes, it goes without saying that the switch 19 may be realized as software used in the control unit 9. The HDMI Tx 7 has a function as a transmitting device, and in addition, on the basis of Extended Display Identification Data (EDID), can obtain information about the audio (video) reproduction performance of a television (TV) receiver (television device) connected to the HDMI Tx 7, a monitor device which can display a television broadcast program and the like, and an audio-video (AV) amplifier (controller) which is often used with the monitor device.

Although not described in detail, the control block 9 includes a CPU or MPU (main control unit) and includes at least an Audio Stream selection processing part 9-1, an Audio Stream setting extraction processing part 9-3, an Elementary Stream setting extraction processing part 9-5, an audio format switching processing part 9-7, which are controlled by the CPU or the MPU, and a comparison processing part 9-9 for comparing the setting of the Audio Stream and the setting of the Elementary Stream. The control block 9 is connected with a main memory (SDRAM) 21 operating as a work memory and an HDD (not shown) for storing an arbitrary program and a content group of a terrestrial or satellite digital broadcasting input through a tuner part or an external input (not shown) and a data group (an arbitrary number of scenes and stream groups associated with content, that is, playlists) supplied from an external network through a network controller (not shown).

The DSP (signal processing part) 11 can process video and audio data of the well-known packetized stream (PS) data format and digital broadcast video and audio data of the transport stream (TS) format.

Video, audio, and other control data are time-division multiplexed with the PS. Further, the video and audio are respectively transmitted in a compressed format for the purpose of reducing each data amount to be transmitted. Many data are video data and compressed in a format called, for example, H. 264, VC-1, MPEG2, MPEG4 AVC (often simply called AVC).

As an audio signal, in addition to the above data format, there is high-bitrate (HBR) audio which is not decoded and is supplied from the HDMI Tx 7 to a receiving device such as a television receiving device and an AV amplifier.

In the video and audio reproduction device 1, a video signal, that is, a video image passes through the HDMI Tx 7 to be output to an audio-video (AV) receiver, a general television (TV) device (with a speaker), or a monitor device typified by a liquid crystal display and CRT.

Meanwhile, there are two types of the audio signals, one of which is an HBR audio signal which is no decoded and has passed through the HBR audio conversion processing part 17 and the other of which is an audio signal decoded in the audio decoder part 15. At least one of the audio signals is supplied to the HDMI Tx 7 by the switch 19. Incidentally, the Audio Stream, which passes through the HBR audio conversion processing part 17 to be output directly to the HDMI Tx 7, is a stream typified by “Dolby Digital plus (DD+)” and “Dolby True HD” recommended by Dolby, “DTS-HD High-Resolution Audio (DTS-HD HI RES)” and “DTS-HD Master Audio (DTS-HD MSTR)” recommended by DTS, and the like, in other words, the Audio Stream is a bitstream output.

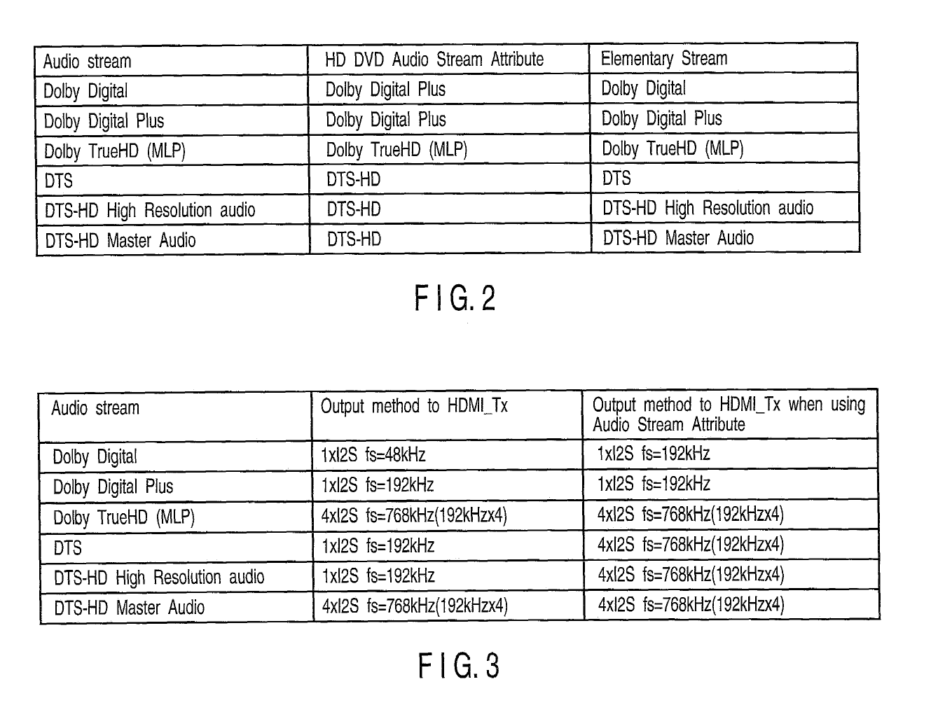

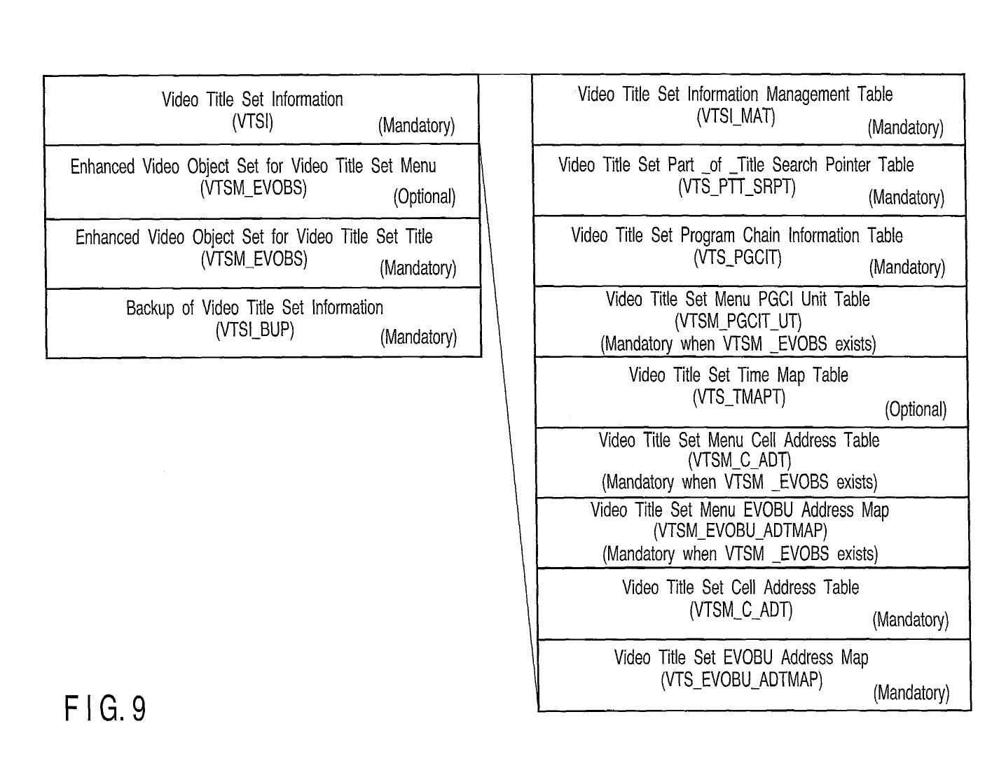

Each audio output format of the above bitstream outputs (HBR audio) upon transmission of the HBR audio to the HDMI Tx7 is specified; however, as the outline shown in FIG. 2, in HD DVD format of Ver 1.0, in Audio Stream Attribute in Video Management Information (VMGI)/Video Title Set Information (VTSI [see, FIG. 9]) of HD DVD,

“Dolby Digital (DD)” and “Dolby Digital plus (DD+)” are described as “DD+”, and

“DTS core”, “DTS-HD High-Resolution Audio”, and “DTS-HD MSTR” are descried as “DTS-HD”.

Therefore, with respect to the Audio Stream described as “DD+” or “DTS-HD”, the output format of the HBR audio sometimes cannot be properly switched.

For example, as the outline shown in FIG. 3, regarding “DTS-HD”, “DTS-HD High-Resolution Audio” is determined to be the same as “DTS core”, and the audio format in the Audio Stream is sometimes transmitted to the HDMI Tx 7 with a format different from the original format.

In that case, when a display region in which the name of the Audio Stream can be displayed or markers such as LED is provided in a receiving device connected to the HDMI Tx 7, for example, in an AV receiver, the name of the Audio Stream sometimes cannot be correctly displayed.

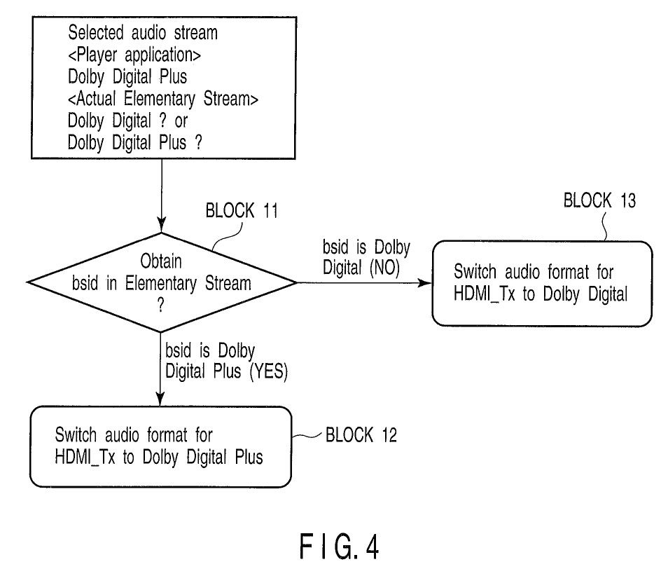

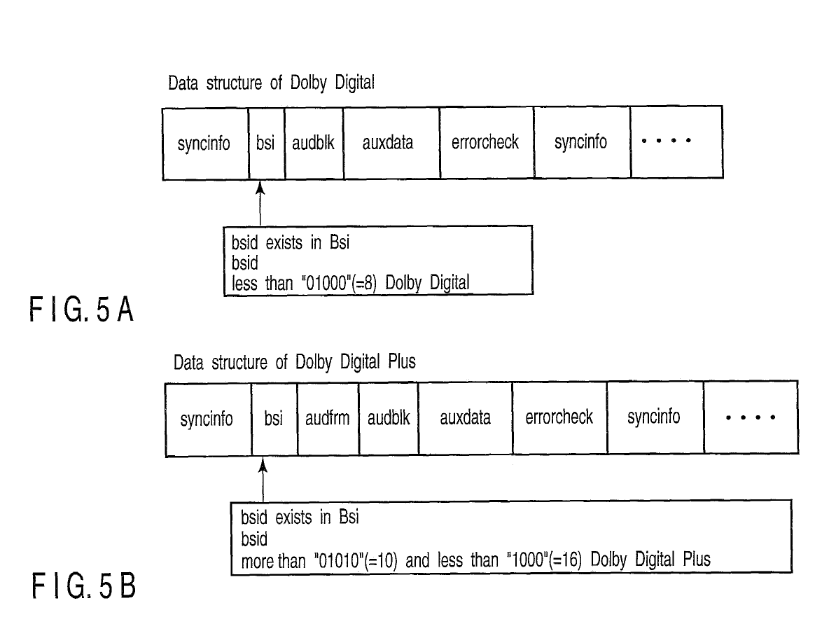

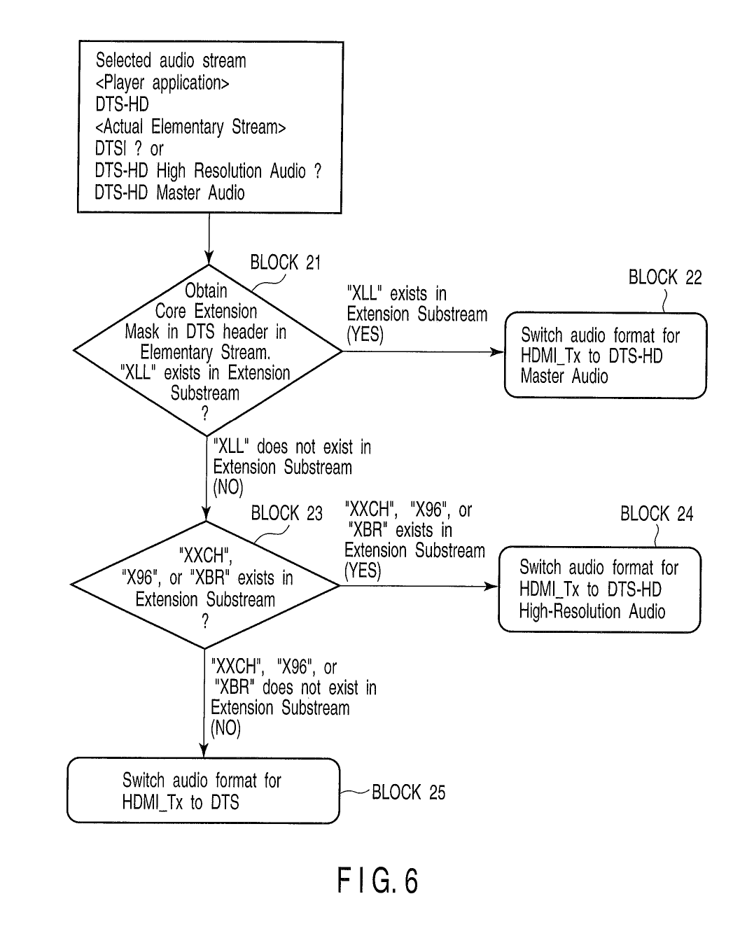

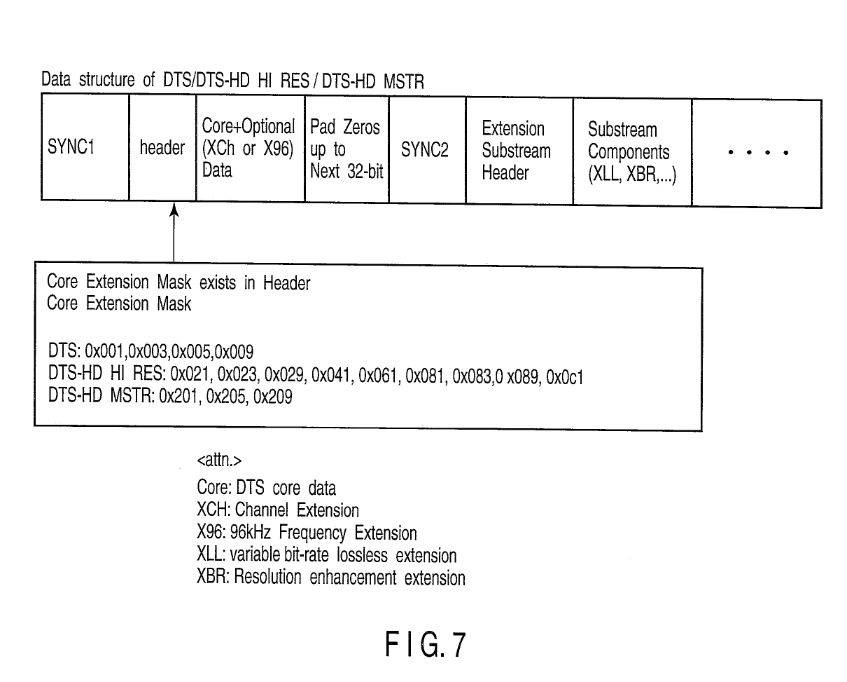

In order to solve the above problem, the format of the Audio Stream is judged from the header information in the Elementary Stream, whereby it can be reliably switched, as will be described using FIGS. 4, 5A and 5B (“Dolby Digital”) and FIGS. 6 and 7 (“DTS-HD”).

As shown in FIG. 4, when a Player application in the header information in the data structure in the selected Audio Stream is “Dolby Digital Plus”, whether the actual Elementary Stream is “Dolby Digital” or “Dolby Digital Plus” is determined, whereby the format of the Audio Stream can be reliably switched.

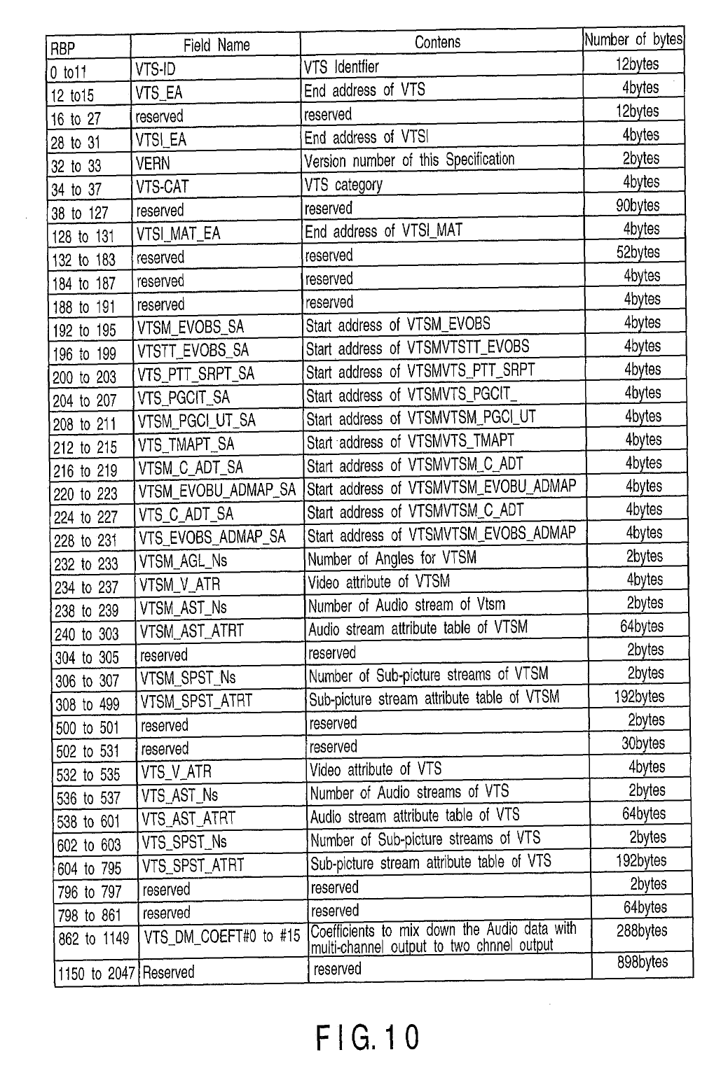

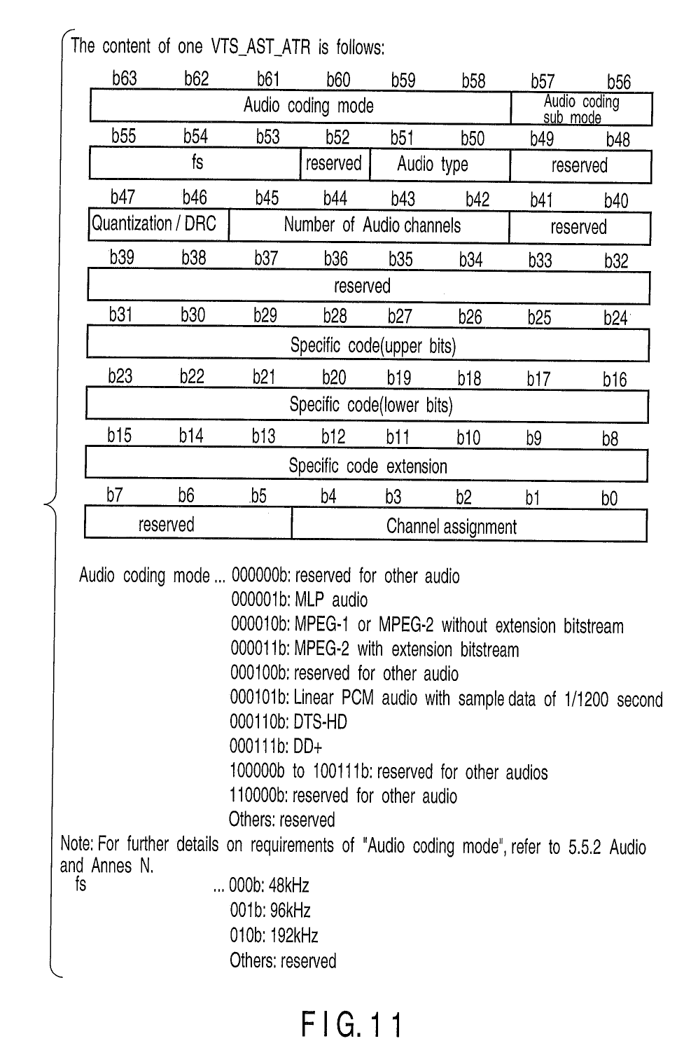

As shown in FIG. 4, a Video Title Set Information Management Table (VTSI_MAT, FIG. 9) in Video Title Set Information (VTSI) within a data region of an optical disc is first referred, and an Audio Stream attribute table of VTS (FIG. 10) in the VTSI_MAT is further referred. FIG. 11 describes in detail a description example of Audio Stream attribute table shown in FIG. 10.

The Elementary Stream shown in FIG. 2 is described in the Audio Stream attribute table in the VTSI_MAT, and even in the Audio Stream in which the Audio Stream attribute is described as “Dolby Digital Plus”, it is possible to easily distinguish “Dolby Digital” from “Dolby Digital Plus (DD+)”.

Namely, as shown in FIG. 4, bsi of the Elementary Stream (see FIGS. 5A and 5B) is referred from the data region in the disc and, when bsid exists in the bsi, the size (described numeric value) is obtained (BLOCK 11).

When the obtained numeric value (size) of bsid is “more than “01010” (=10) and less than “10000” (=16)” representing “Dolby Digital Plus” (see, FIG. 5B) (BLOCK 11—YES), the audio format in the Audio Stream in the content is “Dobly Digital Plus”, and therefore, the audio format to be output to the HDMI Tx 7 is set to “Dolby Digital Plus” (BLOCK 12).

Meanwhile, when the bsi is “less than “01000” (=8)” representing “Dolby Digital” (see, FIG. 5A) (BLOCK 11—NO), the audio format to be output to the HDMI Tx 7 can be switched to “Dolby Digital” (BLOCK 13).

As described above, the description of the Elementary Stream in the Audio Stream attribute table in the VTSI_MAT within the data region in the HD DVD disc is referred, whereby it is possible to prevent the audio format in the Audio Stream from being transmitted (output) to the HDMI Tx 7 with a format different from the original format.

FIG. 6 shows an example of a method for specifying the header information in the actual Elementary Stream from among “DTS core”, “DTS-HD High-Resolution Audio”, and “DTS-HD MSTR” when the Player application in the header information in the data structure in the selected Audio Stream is “DTS-HD”.

As shown in FIG. 6, when the Player application in the header information in the data structure in the selected Audio Stream is “DTS-HD”, a Video Title Set Information Management Table (VTSI_MAT, see FIG. 9) in Video Title Set Information (VTSI) within the data region in an optical disc is first referred, and the audio format in each “DTS-HD” Audio Stream (see FIG. 7) is then checked (referred).

First, Core Extension Mask (see FIG. 7, a flag representing the type of extended data included in the stream) in the header in the Elementary Stream is checked from the data region in an HD DVD disc, and whether the Core Extension Mask includes “XLL (variable bit-rate lossless extension)” is determined (BLOCK 21).

When the “XLL” exists in the Core Extension Mask (BLOCK 21—YES), the audio format in the Audio Stream is “DTS-HD Master Audio (DTS-HD MSTR)”, and therefore, the audio format to be output to the HDMI Tx 7 is set to “DTS-HD MSTR (DTS-HD Master Audio)” (BLOCK 22).

When “XLL” does not exist in the Core Extension Mask (BLOCK 21—NO), it is determined whether there is “XXCH”, “X96”, or “XBR (Resolution enhancement extension)” in the Core Extension Mask (BLOCK 23). “XXCH” represents that the surround exceeds 6.1 channels. “X96” represents that a sampling rate fs is 48 kHz×2. In “XBR”, a numeric value represented by X represents a bit rate, and “XBR” represents that it is High-Bitrate Audio (HBR).

In BLOCK 23, when any of “XXCH”, “X96”, and “XBR” exist in the Core Extension Mask (BLOCK 23—YES), the audio format in the Audio Stream is “DTS-HD High-Resolution Audio (DTS-HD HI RES)”, and therefore, the audio format to be output to the HDMI Tx 7 is set to “DTS-HD HI RES (DTS-HD High-Resolution Audio” (BLOCK 24).

In BLOCK 23, when there are no “XXCH”, “X96”, and “XBR” in the Core Extension Mask (BLOCK 23—NO), the audio format in the Audio Stream is (normal) “DTS core”, and therefore, the audio format to be output to the HDMI Tx 7 is set to “DTS core” (BLOCK 25).

As described above, the header information in the actual Elementary Stream in the header information in the data structure in the HD DVD disc is referred, whereby the audio format in the Audio Stream is prevented from being transmitted (output) to the HDMI Tx 7 with an audio format different from the original audio format.

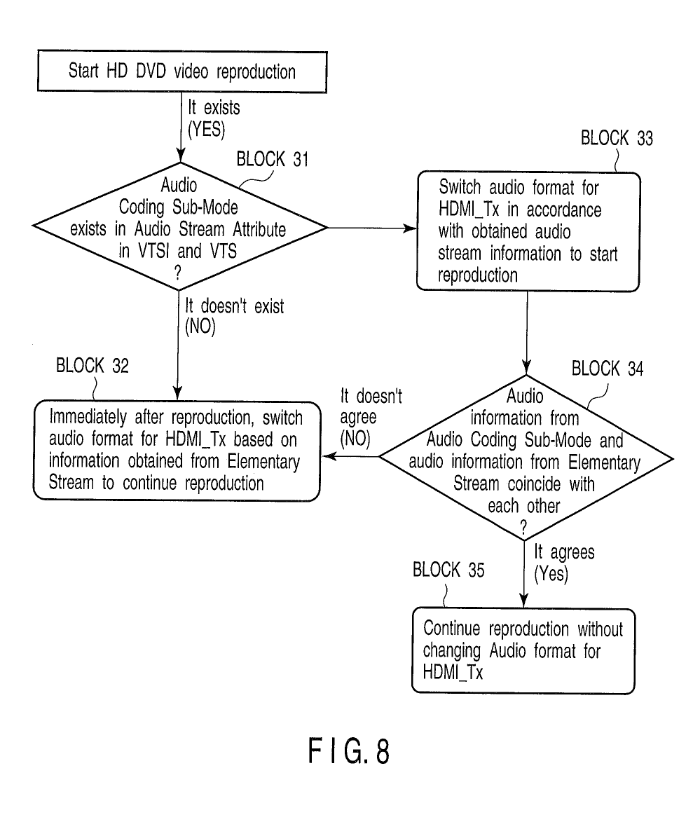

FIG. 8 shows an example of a method for setting the audio format in the Audio Stream to be output to a receiving device in the reproduction of the HD DVD disc actually set in the video and audio reproduction device, with respect to the selected Audio Stream shown in FIGS. 4, 5A, and 5B or FIGS. 6 and 7. FIG. 8 also describes the setting of the audio format in the case where, when an audio coding sub-mode is specified in the Audio Stream Attribute, an audio format specified in the audio coding sub-mode and an audio format obtained by the method described in FIGS. 4 to 7 do not coincide with (differ from) each other.

An HD DVD disc is set in the video and audio reproduction device, and when the reproduction of content is instructed (by a user) through a remote terminal (not shown), it is checked whether the audio coding sub-mode exists in the Audio Stream Attribute in Video Title Set Information (VTSI [see, FIG. 9])/VTS (BLOCK 31).

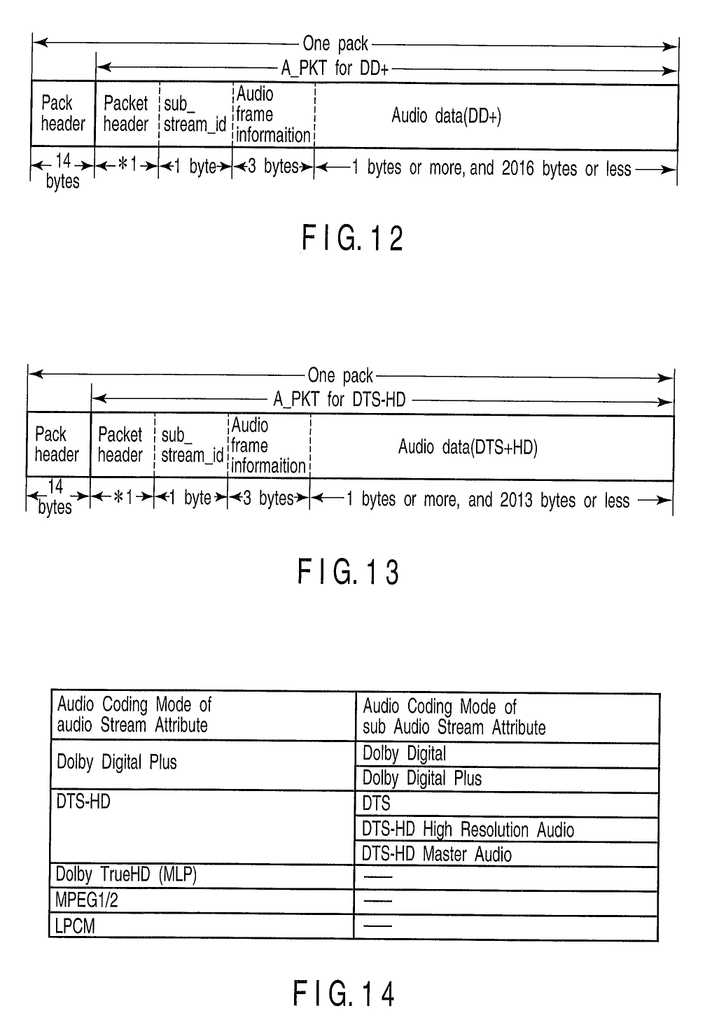

When the audio coding sub-mode exists (BLOCK 31—YES), even if the description in the Audio Coding Mode in the Audio Stream Attribute is only “Dolby Digital Plus (DD+)”, as shown in FIG. 12, “Dolby Digital” and “Dolby Digital Plus (DD+)” are clearly shown in the Audio Coding Mode in the audio coding sub-mode.

In addition, also with regard to “DTS” recommended by DTS, as shown in FIG. 13, even if the description in the Audio Coding Mode in the Audio Stream Attribute is only “DTS HD”, “DTS-HD High-Resolution Audio” and “DTS-HD MSTR” are clearly shown in the Audio Coding Mode in the audio coding sub-mode.

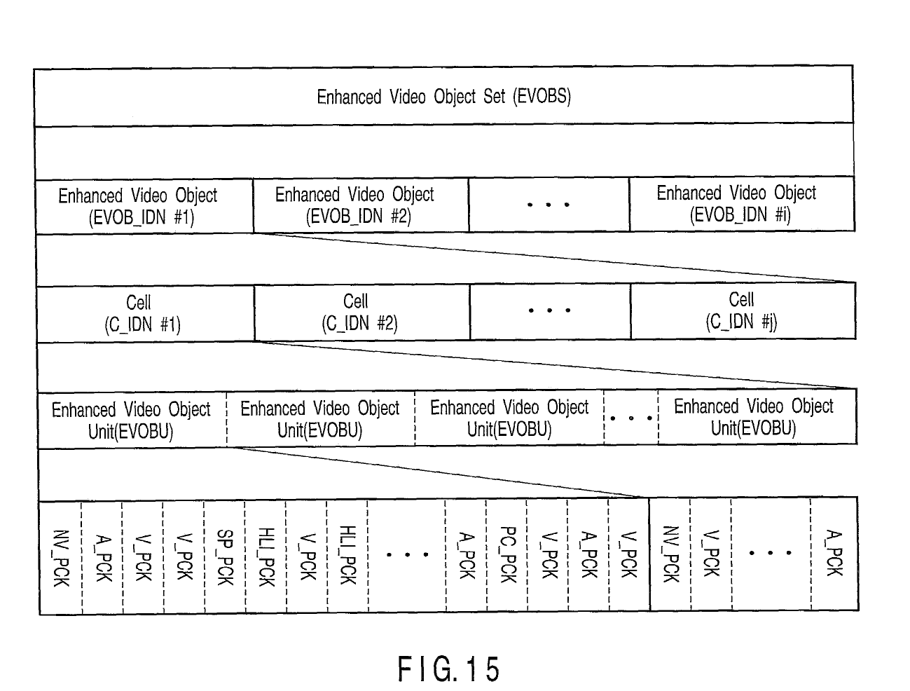

For details, the audio coding sub-mode is specified as a description showing that “Audio data (DD+)”, that is, the audio format is “Dolby Digital Plus” or “Dolby Digital” (see FIG. 12) or a description showing that the “Audio data (DTS_HD)”, that is, the audio format is any of “DTS_HD”, “DTS_HD High-Resolution Audio”, and “DTS_HD MSTR” (see FIG. 13) in an audio data region in a plurality of audio packs (A_PCK) respectively provided in Enhanced Video Object Units (EVOBUs) respectively specified in an arbitrary number of Enhanced Video Objects (EVOs) provided in an Enhanced Video Object Set (EVOBS) within a data region shown in FIG. 15.

Accordingly, when there is no audio coding sub-mode (BLOCK 31—NO), immediately after starting the reproduction, the audio format, obtained by the method described in FIGS. 4 to 7, is selected as the audio format to be output (transmitted) to the HDMI Tx 7 (BLOCK 32).

Meanwhile, when there is the audio coding sub-mode (BLOCK 31—YES), an audio signal is first output (transmitted) to the HDMI Tx 7 with the audio format described in the audio coding sub-mode (BLOCK 33).

Subsequently, the audio format described in the audio coding sub-mode and the audio format which is set based on the Elementary Stream and is being transmitted to the HDMI Tx 7 are compared with each other (BLOCK 34). When those audio formats do not coincide with each other (BLOCK 34—NO), the audio signal is output by the method described in FIGS. 4, 5A, and 5B or FIGS. 6 and 7, that is, by setting the audio format based on the Elementary Stream (BLOCK 32). When those audio formats coincide with each other (BLOCK 34—YES), it goes without saying that the audio signal is transmitted (output) to the HDMI Tx 7 with the audio format described in the audio coding sub-mode (BLOCK 35).

The data described in the audio coding sub-mode includes data shown in FIG. 14, for example.

According to the reproduction method shown in FIG. 8, the audio format in the Audio Stream can be specified (set) immediately before the reproduction of content, and therefore, the Audio Stream to be output to the HDMI Tx 7 is prevented from being delayed. In addition, if the description of the audio coding sub-mode does not coincide with the audio format set based on the Elementary Stream, or if the content does not include the description of the audio coding sub-mode, the audio signal with a correct audio format can be output based on already obtained correct Audio Stream information.

As described above, according to one embodiment of the invention, in a moving image reproduction device which reproduces the content from a recording medium such as an HD DVD disc (or a recorder device which can record the content), when a high-bitrate (HBR) audio output as a bitstream output is supplied (output) to a receiving device, such as a television device and an audio amplifier, by using an HDMI interface, an HBR audio output format typified by “Dolby Digital plus (DD+)” recommended by Dolby, “DTS-HD High-Resolution Audio (DTS-HD HI RES)”/“DTS-HD Master Audio (DTS-HD MSTR)” recommended by DTS, and so on can be properly reproduced based on the original format. Namely, the Audio Stream information is obtained from the Elementary stream or the Header information in the Elementary stream, and the audio format to be transmitted/output to a receiving device can be reproduced in accordance with the stream, using the obtained information. The audio format can be arbitrarily changed (a specified audio format can be designated) by a user.

In addition, when a display region in which the name of the Audio Stream can be displayed or markers such as LED is provided in, for example, the AV receiver (audio amplifier), the accurate name of the Audio Stream can be displayed.

Furthermore, the audio format is not required to be set in accordance with the audio reproduction performance of the connected device, and the best audio output included in content can be reproduced.

Namely, the highest CODEC for a receiving device is selected from a plurality of audio CODECs applied to the content including the Audio Stream in the audio format capable of being reproduced by a receiving device to allow the output to the receiving device. According to this constitution, a user can obtain the best audio output, which can be reproduced by each receiving device, only by connecting all the receiving devices to a moving image and audio reproduction device.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The present invention is not limited to the embodiments described above and can be modified in various manners without departing from the spirit and scope of the invention.

For example, the present invention can provide a method for moving image and audio reproduction in a video and audio reproduction device, comprising: extracting an audio coding sub-mode in an Audio Stream Attribute in a Video Title Set Information included in content; and distinguishing the Audio Stream from the extracted setting of the Audio Coding mode in the audio coding sub-mode and switching the audio format in the Audio Stream in the content to be output to a transmission device.

What is claimed is:

1. A video and audio reproduction device comprising:
an extraction unit which extracts a composition of an Elementary Stream in an Audio Stream included in content and a setting of the Elementary Stream; and
a reproduction unit which reproduces the Audio Stream in accordance with the composition of the Elementary Stream in the Audio Stream and the setting of the Elementary Stream, extracted by the extraction means.

2. The video and audio reproduction device of claim 1, wherein the an extraction unit detects an audio format in an Audio Stream being set based on a numeric value described in the Elementary Stream.

3. The video and audio reproduction device of claim 1, wherein the an extraction unit detects an audio format in an Audio Stream being set, on the basis of an audio coding mode described in the Elementary Stream.

4. The video and audio reproduction device of claim 1, further comprising:
a transmission device which transmits the Audio Stream reproduced by the reproduction means to a receiving device without decoding the reproduced Audio Stream.

5. The video and audio reproduction device of claim 4, wherein the reproduction unit distinguishes the Audio Stream selected from the composition of the Elementary Stream in the Audio Stream and the setting of the Elementary Stream, extracted by the extraction means, and switches an audio format to be output through the transmission device.

6. A video and audio reproduction device comprising:
an extraction unit which checks whether an audio coding sub-mode exists in an Audio Stream Attribute in Video Title Set Information included in content;
a reproduction unit which reproduces the Audio Stream extracted by the extraction means;
a transmission device which transmits the Audio Stream reproduced by the reproduction means to a receiving device; and
a switching unit which distinguishes the Audio Stream from the setting of an Audio Coding Mode in the audio coding sub-mode extracted by the extraction means and switching an audio format in content to be output to the transmission device.

7. The video and audio reproduction device of claim 6, wherein the switching unit compares the Audio Coding Mode in the audio coding sub-mode extracted by the extraction unit with previously obtained information of the audio format which is set as the Elementary Stream in the Audio Stream and, when the Audio Coding Mode and the information set as the Elementary Stream do not coincide with each other, gives preference to the information set as the Elementary Stream.

8. A method for moving image and audio reproduction in a video and audio reproduction device, comprising:
extracting a composition of an Elementary Stream in an Audio Stream included in content and a setting of the Elementary Stream; and
reproducing the Audio Stream in accordance with the extracted composition of the Elementary Stream in the Audio Stream and the extracted setting of the Elementary Stream.

9. The method for moving image and audio reproduction in a video and audio reproduction device of claim 8, wherein the extraction of the composition of the Elementary Stream and the setting of the Elementary Stream is the extraction of a numeric value of the Elementary Stream.

10. The method for moving image and audio reproduction in a video and audio reproduction device of claim 8, wherein the extraction of the composition of the Elementary Stream and the setting of the Elementary Stream is the detection of the audio format in the Audio Stream which is set in accordance with an audio coding mode shown in the Elementary Stream.
